(19) United States
(12) Patent Application Publication
(10) Pub. No.: US 2011/0068627 A1
(43) Pub. Date: Mar. 24, 2011

(54) Method of Obtaining DC Microgrid Having Minimized Power Loss

(75) Inventor: Ting-Chia Ou, Taoyuan (TW)

(73) Assignee: ATOMIC ENERGY COUNCIL-INSTITUTE OF NUCLEAR ENERGY RESEARCH, Taoyuan County (TW)

(21) Appl. No.: 12/706,121

(22) Filed: Feb. 16, 2010

(30) Foreign Application Priority Data
Sep. 24, 2009 (TW) 098132229

(51) Int. Cl. H02J 3/00

(52) U.S. Cl. 307/42

(57) ABSTRACT

Power loss of a direct-current microgrid is analyzed. The process includes initialization and statistics; mutation; competition and convergence test; adaptive mutation; and taboo search. Rearrangement of the microgrid can be figured out in a short time. Thus, power loss is minimized and service can be quickly recovered.

### CROSS REFERENCE TO RELATED PATENT APPLICATIONS

This application claims priority from Taiwan Patent Application No. 098132229, filed in the Taiwan Patent Office on Sep. 24, 2009, entitled “Method of Obtaining DC Microgrid Having Minimized Power Loss,” and incorporates the Taiwan patent application in its entirety by reference.

### TECHNICAL FIELD

The present disclosure relates to obtaining a best network configuration; more particularly, relates to obtaining a direct current (DC) microgrid having a minimized power loss, where power loss of a DC microgrid is reduced and its service is recovered soon.

### DESCRIPTION OF THE RELATED ART

Power resources for general microgrids are renewable energies, like energies generated from photovoltaic devices, wind turbines, fuel cells, hydro plants, etc., where batteries, super capacitors and flywheels are used as energy storage devices. These power resources and energy storage devices usually generate DC voltage or alternative current (AC) voltage, whose amplitude and frequency are different from those of city grids. Hence, power converters are required to be used as interfaces for being connected with the city grids. When the microgrids are connected with the city grids, the renewable energies generate active power and reactive power. However, when the microgrids are run in island mode, voltages and frequencies of the power resources have to be adjusted; and, thus, different operation mode for the renewable energies are invented.

A DC microgrid structure can be applied to adjust the renewable energies, which can stably obtain distributed generation and thus apply high-quality power. The power is transmitted through a three-Wire DC distributed power system, whose voltage has to be stable to maintain a high-quality power supply with a data center having high-reliability and low loss applied for the DC microgrids. Furthermore, low-voltage DC used in sensitive electronic loads applied in commercial power system is better than AC voltage.

Hence, the DC microgrid structure not only saves power and reduces loss; but also reduces cost of forward rectifiers, where the energy storage devices are directly connected to the system. Since there are many always-open and always-close switches in the DC distributed power system of the DC microgrid, re-distribution can be done to reduce power loss, where states of the switches can be changed to transmit load current from a zone to other renewable energy resources zone (RERZ). When error happens to the system, switches can be used to block error zones and to recover service.

The redistribution of the DC microgrid is an important technology. Yet, some redistribution operations are very dangerous and the decision may not be based on power loss. Hence, the prior arts do not fulfill all users' requests on actual use.

### SUMMARY OF THE DISCLOSURE

The main purpose of the present disclosure is to obtain a DC microgrid having a minimized power loss, where power loss of a DC microgrid is reduced and its service is recovered soon by obtaining a best network configuration.

To achieve the above purpose, the present disclosure is a method of obtaining a DC microgrid having a minimized power loss, comprising steps of: (a) obtaining power loss of each mesh and state of each switch in a microgrid; (b) obtaining circuit combinations of all meshes to find a best solution with a minimized power loss calculated through

$$[ {y}_{i + p} ] = [ {S}_{j , Q + m} ] j = 1 , … , n ;$$

$$m = ceil ( N ( 0 , 2 ) ) ; and {σ}^{2} = β * {j}_{s} * \frac{{F}_{i}}{{F}_{avg}} ;$$

(c) selecting one of the combinations through

$${W}_{i} = {\sum }_{t = 1}^{N} {W}_{i , t} and \frac{{F}_{avg} - {F}_{min}}{{F}_{min}} < ɛ$$

until a largest output number is obtained, where

$${W}_{i , t} = \{ \begin{matrix}1 & rand < \frac{{F}_{r}}{{F}_{r} + F} \\ 0 & otherwise ;\end{matrix}$$

(d) adjusting parameters through

$$n ( g + 1 ) = \{ \begin{matrix}n ( g ) + 1 ; n ( g ) = 1 & for {F}_{min} ( g ) = {F}_{min} ( g - 1 ) \\ n ( g ) - 1 ; n ( g ) = 1 & for {F}_{min} ( g ) = {F}_{min} ( g - 1 ) \\ n ( g ) & for {F}_{min} ( g ) < {F}_{min} ( g - 1 ) ;\end{matrix}$$

and (e) avoiding taboo rules. Accordingly, a novel method of obtaining a DC microgrid having a minimized power loss is obtained.

### BRIEF DESCRIPTION OF THE DRAWINGS

The present disclosure will be better understood from the following detailed description of the preferred embodiment according to the present disclosure, taken in conjunction with the accompanying drawings.

FIG. 1 is the view showing the flow of the preferred embodiment according to the present disclosure.

FIG. 2 is the view showing the DC microgrid according to the present disclosure.

FIG. 3 is the view showing the arrangement of the switches according to the present disclosure.

FIG. 4 is the view showing the combinations of the switches according to the present disclosure.

FIG. 5 is the view showing the robustness test.

FIG. 6 is the view showing the load test.

### DESCRIPTION OF THE PREFERRED EMBODIMENT

The following description of the preferred embodiment is provided to understand the features and the structures of the present disclosure.

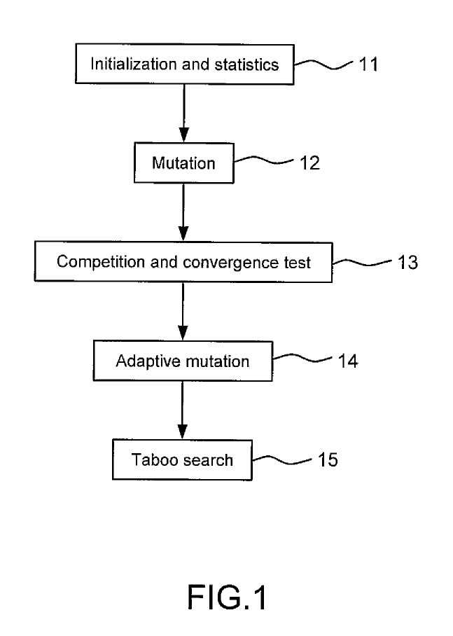

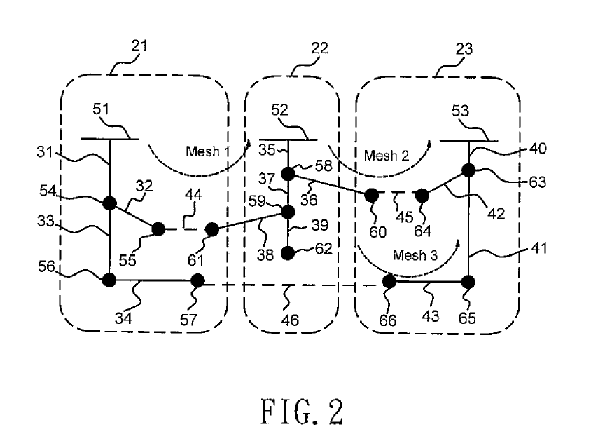

Please refer to FIG. 1 to FIG. 6, which are a view showing a flow of a preferred embodiment according to the present disclosure; a view showing a DC microgrid; a view showing an arrangement of switches; a view showing combinations of switches; a view showing a robustness test; and a view showing a load test. As shown in the figures, the present disclosure is a method of obtaining a DC microgrid having a minimized power loss. In FIG. 2, the present disclosure is applied to a grid of three renewable energy resources zones (RERZ), comprising a first to a thirteenth sectionalizing switches 31˜43; a first to a third connecting switches 44˜46; and a first to a sixteenth backup switch 51˜66. In the grid, the connecting switches 44˜46 are always open for changing the grid from a radial grid into a mesh grid. In order to change the grid back to the radial grid, the backup switches 51˜66 have to be recognized, where the backup switches 51˜66 are a series of individual switches and a sum of the backup switches 51˜66 is a population size in a mixed programming design. The present disclosure comprises the following steps:

(a) Initialization and statistics 11: Power loss of each mesh and state of each switch in the microgrid is obtained.

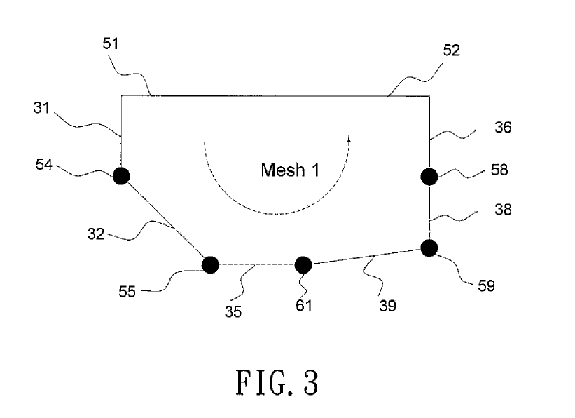

S_{j,Q} means a switch in mesh j and {S_{j,Q}} means the set of all switches in mesh j, where Q is a sequential number of the switch. In FIG. 2, there are three RERZs 21,22,23. An initial switch matrix Yᵢ=[y₁ y₂ . . . yₚ]^{T}=[S_{j,Q}] and yᵢ=y₂=yₚ=[(the 8^{th} sectionalizing switch 38) (the 1^{st} connecting switch 44) (the 3^{rd} connecting switch 46)]≡[S_{1,4} S_{2,3} S_{3,3}], where p is the population size. It is defined that, for an circular arrangement shown in FIG. 3, the 8^{th} sectionalizing switch 38=S_{1,4}, the 7^{th} sectionalizing switch 37=S_{1,5}=S_{3,9} and the 1^{st} connecting switch 44=S_{1,3}=S_{3,11}. Therein, an objective function,

$$F = {P}_{loss} ( {S}_{v} ) + {\sum }_{k = 1}^{N} {{λ}_{{V}_{k}} ( {V}_{k} - {V}_{k}^{lim} )}^{2} + {\sum }_{k = 1}^{{N}_{b}} {λ }_{{I}_{k}} {( {I}_{k} - {I}_{k}^{lim} )}^{2} ,$$

is used as a fitness function for each individual switch to figure out a minimum fitness function Fₘᵢₙ and an average fitness function F_{avg}.

(b) Mutation 12: Circuit combinations of all meshes are figured out and a best solution is found with a minimized power loss calculated.

In the mixed programming design, each mesh has mutations. It is assumed that an i^{th} individual mesh Yᵢ has n elements and each mutation of yᵢ is assigned to yᵢ₊ₚ; and, thus, a 2p number of individual messes are produced to be added to a p number of individual messes.

For the same mesh j, the individual mesh is mutated in switches according to their sequential numbers. It is assumed that yᵢ=S_{j,Q}; and, thus, mutated elements are defined as [yᵢ₊ₚ]=[S_{j,Q+m] j=}1, . . . , n, where Q is the sequential switch number. Therein, formulas of m=ceil(N(0,σ²)) and

$${σ}^{2} = β * {j}_{s} * \frac{{F}_{i}}{{F}_{avg}}$$

are used, where N(μ,σ²) has μ as a mean and σ² as a Gaussian variance; β is a mutation size; jₛ is a switch number in mesh j; F_{avg} is an average fitness function; and Fᵢ is a fitness function of an i^{th} individual switch. For a new output, the size of β is adjusted and normally described. In FIG. 2, it is assumed that an initial switch number y₁=y₂=y₃=[(the 8^{th} sectionalizing switch 38) (the 1^{st} connecting switch 44) (the 3^{rd} connecting switch 46)]=[S_{1,4} S_{2,3} S_{3,3}]; and, thus,

$$[ \begin{matrix}{y}_{1} \\ {y}_{2} \\ {y}_{3}\end{matrix} ] = [ \begin{matrix}{S}_{1 , 4} & {S}_{2 , 3} & {S}_{3 , 3} \\ {S}_{1 , 4} & {S}_{2 , 3} & {S}_{3 , 3} \\ {S}_{1 , 4} & {S}_{2 , 3} & {S}_{3 , 3}\end{matrix} ] .$$

In a mutated matrix m,

$$m = [ \begin{matrix}0 & - 1 & 1 \\ - 1 & - 1 & 0 \\ - 1 & 0 & 2\end{matrix} ]$$

can be randomly figured out. All Q sub-indices of the mutated mesh are collected and the

$$[ \begin{matrix}{y}_{4} \\ {y}_{5} \\ {y}_{6}\end{matrix} ] = [ \begin{matrix}{S}_{1 , 4} & {S}_{2 , 2} & {S}_{3 , 4} \\ {S}_{1 , 3} & {S}_{2 , 2} & {S}_{3 , 3} \\ {S}_{1 , 3} & {S}_{2 , 3} & {S}_{3 , 5}\end{matrix} ] .$$

mutated matrix is described as

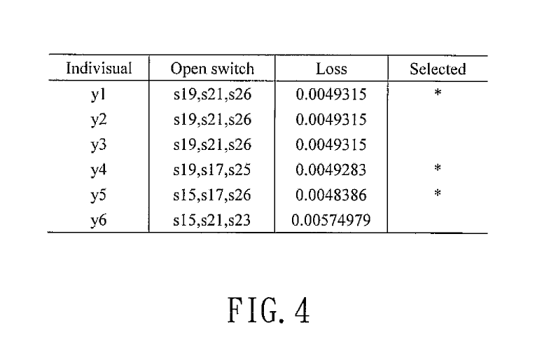

In FIG. 4, all combinations of switch numbers are shown where three combinations having lowest cost are selected as initial switch numbers for next output.

(c) Competition and convergence test 13: One of the combinations is selected until a largest output is obtained.

The individual switches having best fitness functions keep their abiding mesh mutations. Therein, combinations having a 2p-k population size are competed. A weight of Wᵢ is defined as a competition index and

$${W}_{i} = {\sum }_{t = 1}^{N} {W}_{i , t}$$

is defined for an i^{th} individual switch, where N is a competition number randomly generated and is smaller than p. After all of the competitions between each i^{th} individual switch and a randomly selected r^{th} individual switch in all of the combinations, the value of W_{i,t} is overwritten as 0 (when it loses the competition) or 1 (when it wins the competition), i.e.

$${W}_{i , t} = \{ \begin{matrix}1 & rand < \frac{{F}_{r}}{{F}_{r} + F} \\ 0 & otherwise .\end{matrix}$$

After the competitions, the 2p-k number of individual switches will be ordered descendingly according to Wi. For the individual switches having the same weights, their fitness functions are competed. Except the k number of kept individual switches, the leading p-k number of individual switches are selected for next output and the selection ends when a convergence criterion is satisfied, which is when the biggest output number is obtained. It means

$$\frac{{F}_{avg} - {F}_{min}}{{F}_{min}} < ɛ ,$$

where ε is set as 0.05 in the algorithm.

(d) Adaptive mutation 14: Parameters are adjusted to avoid premature efficiency.

Parameters of control variables are adjusted to avoid premature efficiency. For the same Fₘᵢₙ, the result is the either global or local minimum number, and N is adjusted according to the following formula:

$$n ( g + 1 ) = \{ \begin{matrix}n ( g ) + 1 ; n ( g ) = 1 & for {F}_{min} ( g ) = {F}_{min} ( g - 1 ) \\ n ( g ) - 1 ; n ( g ) = 1 & for {F}_{min} ( g ) = {F}_{min} ( g - 1 ) \\ n ( g ) & for {F}_{min} ( g ) < {F}_{min} ( g - 1 ) ,\end{matrix}$$

where g is the output number.

(e) Taboo search 15: Taboo rules are avoided.

Taboo rules are built and defined as follows:

(1) After a best result for the output number is obtained, the calculations stop.

(2) When a newest best local result is obtained, the calculations stop.

(3) When the number of individuals violates electric constraint, the calculations stop.

(4) When any arch structure is not figured out or only randomly-unloaded try-and-error results are found, the calculations stop—e.g. the border between two abiding meshes contains more than two simultaneously-open switches.

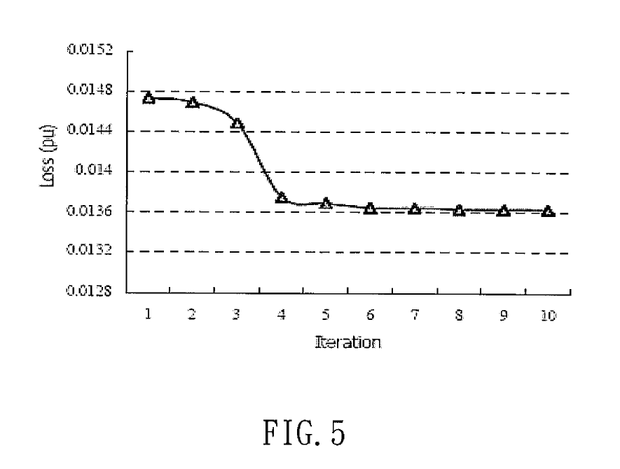

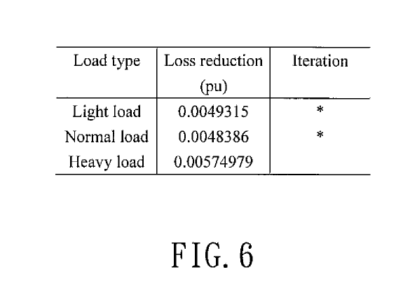

The present disclosure can be used for complex network. In FIG. 5, situations having various loads are shown, where cost for strength is reduced when p=10. In the other hand, the outputs are generated increasingly at 6 folds, where outputs smaller than 10 folds are generated as usual and their performances having light/normal/heavy loads are shown in FIG. 6.

The present disclosure provides a best configuration of a DC microgrid, where power loss is reduced to a lowest level; service is recovered as soon as possible; premature is avoided; and taboo rules are used to improve efficiency. It shows that the present disclosure has its outputs converged fewer than 10 folds. When service is recovered, candidate switches are considered to recover load points. Thus, the present disclosure is faster, more robust and more efficient with costs for planning and operating reduced at the same time.

To sum up, the present disclosure is a method of obtaining a DC microgrid having a minimized power loss, where power loss of a DC microgrid is reduced and its service is recovered soon by obtaining a best network configuration.

The preferred embodiment herein disclosed is not intended to unnecessarily limit the scope of the disclosure. Therefore, simple modifications or variations belonging to the equivalent of the scope of the claims and the instructions disclosed herein for a patent are all within the scope of the present disclosure.

What is claimed is:

1. A method of obtaining a DC microgrid having a minimized power loss, the method comprising:
(a) obtaining power loss of each mesh and state of each switch in a microgrid;
(b) obtaining circuit combinations of all meshes to find a best solution with a minimized power loss calculated through
$$[ {y}_{i + p} ] = [ {S}_{j , Q + m} ] j = 1 , … , n ;$$
$$m = ceil ( N ( 0 , {σ}^{2} ) ) ; and {σ}^{2} = β * {j}_{s} * \frac{{F}_{i}}{{F}_{avg}} ;$$
(c) selecting one of said combinations through
$${W}_{i} = {\sum }_{t = 1}^{N} {W}_{i , t} and \frac{{F}_{avg} - {F}_{min}}{{F}_{min}} < ɛ$$
until a convergence criterion is satisfied,
wherein
$${W}_{i , t} = \{ \begin{matrix}1 & rand < \frac{{F}_{r}}{{F}_{r} + F} \\ 0 & otherwise ;\end{matrix}$$
and
wherein said convergence criterion is to obtain a largest output number;
(d) adjusting parameters through
$$n ( g + 1 ) = \{ \begin{matrix}n ( g ) + 1 ; n ( g ) = 1 & for {F}_{min} ( g ) = {F}_{min} ( g - 1 ) \\ n ( g ) - 1 ; n ( g ) = 1 & for {F}_{min} ( g ) = {F}_{min} ( g - 1 ) \\ n ( g ) & for {F}_{min} ( g ) < {F}_{min} ( g - 1 ) ;\end{matrix}$$
and
(e) avoiding taboo rules.

2. The method according to claim 1, wherein, in step (b), said N(μ,σ²) has μ as a mean and σ² as a Gaussian variance; β is a mutation size; jₛ is a switch number in mesh j; F_{avg} is an average fitness function; and Fᵢ is a fitness function of an i^{th} individual switch.

3. The method according to claim 1, wherein, in step (d), said g is an output number.
